(19) United States
(12) Patent Application Publication
(10) Pub. No.: US 2016/0017091 A1
(43) Pub. Date: Jan. 21, 2016

(54) PROCESS FOR MAKING STARCH RESIN COPOLYMER

(71) Applicant: POLYMER SPECIALITIES INTERNATIONAL LTD., Newmarket (CA)

(72) Inventors: Bryon Wolff, Aurora (CA); Graham Martyn Chapman, Niagra-On-The-Lake (CA)

(21) Appl. No.: 14/377,439

(22) PCT Filed: Feb. 7, 2013
(86) PCT No.: PCT/CA13/50098

§ 371 Date: Aug. 7, 2014

Related U.S. Application Data
(60) Provisional application No. 61/595,957, filed on Feb. 7, 2012.

(51) Int. Cl. C08G 63/91

(52) U.S. Cl. CPC C08G 63/91

(57) ABSTRACT

A process for making a starch-resin copolymer is described, the process comprising: mixing at least one of a dicarboxylic acid and a dicarboxylic acid anhydride with a starch to yield a starch mixture; adding a liquid mixture including water and a polyol to the starch mixture to produce a functionalized starch; and mixing the functionalized starch with a resin to produce the starch-resin copolymer, wherein the starch used in the process has a low moisture content in comparison with the moisture content of starch used in current processes. Starch-resin copolymers produced by the present process can be biodegradable and compostable.

### FIELD

The present invention pertains to the field of starch-resin copolymers and processes for making starch-resin copolymers.

### BACKGROUND

Plastic packaging presents a major disposal problem for companies and municipalities as it is lightweight and bulky and so does not lend itself to a viable economic and environmentally responsible recycling operations due to expensive handling and transportation costs. Most plastics are also not readily biodegradable. Further, issues such as sustainability, ecology, biodegradability, and recyclability are becoming major considerations in a company's product packaging design, especially with single use disposable packaging.

Starch based polymers can provide biodegradable, sustainable solutions for the manufacture of short-life, single use disposable packaging, consumer goods, and other plastics. Starch is generated from carbon dioxide and water by photosynthesis in plants, and starch copolymer can be entirely biodegradable. Owing to its complete biodegradability, low cost and renewability, starch is a promising candidate for developing sustainable packaging and polymer-based materials. Using starch-based polymers also conserves petrochemical resources, reducing environmental impact. In recent years there has also been much interest in the development of biodegradable plastics in order to reduce the amount of long-lived petroleum-derived plastics in solid waste streams.

One approach to the synthesis of biodegradable plastics is to utilize the naturally occurring biodegradable polymer, starch. However, starch alone typically has very poor mechanical properties for direct application and therefore is often blended with a high performance synthetic polymer such as polyesters. Starch granules exhibit hydrophilic properties and strong inter-molecular association via hydrogen bonding due to the hydroxyl groups in the polymer chain. As starch is a highly polar material, it is immiscible with typical hydrophobic synthetic polymers. This problem may be alleviated to some extent by grafting a compatibilizer molecule, such as, for example, maleic anhydride (MAH), onto the synthetic polymer. This process adds polar groups to the synthetic polymer, aiding miscibility, and also may form direct cross-links between the synthetic polymer and the starch chains.

One starch-polyester graft copolymer is disclosed by Narayan in U.S. Pat. No. 7,985,794, incorporated herein by reference. In the process described by Narayan, all of the materials are mixed together to generate the functionalized starch in a twin screw extruder. The product produced by the process of Narayan yields a polymer with Fourier Transform Infrared Spectroscopy (FTIR) scans having a very strong broad peak in the area of 3200-3400 cm⁻¹, which is indicative of —OH stretching.

This background information is provided for the purpose of making known information believed by the applicant to be of possible relevance to the present invention. No admission is necessarily intended, nor should be construed, that any of the preceding information constitutes prior art against the present invention.

### SUMMARY

Herein is described a process for making a starch-resin copolymer is described, the process comprising: mixing at least one of a dicarboxylic acid and a dicarboxylic acid anhydride with a starch to yield a starch mixture; adding a liquid mixture including water and a polyol to the starch mixture to produce a functionalized starch; and mixing the functionalized starch with a resin to produce the starch-resin copolymer, wherein the starch used in the process has a low moisture content in comparison with the moisture content of starch used in current processes. Starch-resin copolymers produced by the present method can be biodegradable and compostable.

An object of the present invention is to provide an alternative process for making starch-resin copolymers. The starch copolymers produced in accordance with this process may have desirable properties, for example, in comparison to some starch copolymers prepared using single or twin screw extruders.

Another object of the present invention to provide economical and reproducible starch-polyester graft copolymers. Thus, in accordance with one aspect, there is provided a process for making starch-resin copolymer compositions that are biodegradable.

In one aspect, there is provided a process for making a starch-resin copolymer, the process comprising:
a) mixing at least one of a dicarboxylic acid and a dicarboxylic acid anhydride with a starch or modified starch to yield a starch mixture;
b) adding a liquid mixture comprising water and a polyol to the starch mixture to produce a functionalized starch; and
c) mixing the functionalized starch with a resin to produce the starch-resin copolymer.
   wherein prior to mixing the one of the dicarboxylic acid and the dicarboxylic acid anhydride with the starch, the starch has a moisture content of not greater than about 8% wt.

In one embodiment, the starch has a moisture content of not greater than about 5% wt. In another embodiment, the starch has a moisture content of not greater than about 3% wt. In another embodiment,

In another embodiment, prior to step a), a drying step is carried out to dry the starch or modified starch, to generate the starch or modified starch having a moisture content of not greater than about 8% wt.

In another embodiment, the drying step is carried out at a pressure of between about 5 to 20 inches of Hg below atmospheric and at a temperature between about 140 to 280° F., preferably between about 160 to 250° F., and more preferably between about 180-210° F.

In another embodiment, the drying step is performed under a pressure of substantially dry gas, such as substantially dry air, nitrogen, or a combination thereof.

In another embodiment, the process further comprises drying the starch-resin copolymer to a moisture content of not greater than 3%. Preferably, drying the starch-resin copolymer to a moisture content of less than 1.5%, more preferably to a moisture content of less than 0.5%.

In another embodiment, the liquid mixture further comprises an initiator. Preferably, the initiator is an organic peroxide.

In another embodiment, the resin is at least one of a polyester selected from the group consisting of Poly(lactic acid) or polylactide (PLA); poly(glycolic acid) or polyglycolide (PGA); Poly(hydroxyester ether) (PHEE); Adipic acid-diglycidyl ether of Bisphenol A; Poly(hydroxybutyrate-co-valerate); Poly(butylene-succinate) (PBSA); Poly(caprolactone) (PCL); Butanediol-terephthalate-adipate terpolymers (PBAT); Cellulose acetate; Poly(vinyl alcohol) (PVOH); poly(vinylacetate-co-vinylalcohol) (PVAc/VA); poly(β-hydroxybutyrate) (PHB); Poly(β-hydroxybutyrate-co.beta.-hydroxyvalerate) (PHBN); poly(β-hydroxyalkanoates) (PHA); Poly(ester amide) (PEA) and other, biodegradable aliphatic polyesters, and aliphatic-aromatic copolyesters.

In another embodiment, the resin is biodegradable, compostable, or both.

In another embodiment, the at least one of the dicarboxylic acid and dicarboxylic acid anhydride is succinic acid, maleic acid, phthalic acid, citric acid and fumaric acid, succinic anhydride, maleic anhydride, phthalic anhydride, citric anhydride or fumaric anhydride.

In another embodiment, the polyol is glycerol, ethylene glycol, polyethylene glycol, propylene glycol, polypropylene glycol, sorbitol, or a combination thereof.

In another embodiment, mixing the functionalized starch with a resin to produce the starch-resin copolymer is carried out at a temperature of between about 120 to 350° F. Preferably, at a temperature of between about 170 to 300° F., more preferably at a temperature of between about 218 to 260° F.

In another embodiment, the process is carried out in a batch reactor or a continuous reactor.

In another embodiment, the amount of functionalized starch is 40-60% by weight of the starch-resin copolymer.

In another aspect, there is provided a starch-resin copolymer produced by the process of any of the described embodiments.

In another aspect, there is provided a starch-resin copolymer comprising:
a) a functionalized starch comprising a reaction product of a starch or modified starch, and one of a dicarboxylic acid or a dicarboxylic acid anhydride, a polyol, water, and optionally an initiator; and
b) a resin,
wherein the starch or modified starch used to manufacture the functionalized starch has a moisture content of less than 8%.

In another embodiment, the functionalized starch has a moisture content of less than 5%. Preferably, the functionalized starch has a moisture content of less than 3%.

In another embodiment, the starch-resin copolymer has a moisture content of less than about 3%. Preferably, the starch-resin copolymer has a moisture content of less than about 1.5%. More preferably, the starch-resin copolymer has a moisture content of less than about 0.5%.

In another embodiment, the resin is at least one of a polyester selected from the group consisting of Poly(lactic acid) or polylactide (PLA); poly(glycolic acid) or polyglycolide (PGA); Poly(hydroxyester ether) (PHEE); Adipic acid-diglycidyl ether of Bisphenol A; Poly(hydroxybutyrate-co-valerate); Poly(butylene-succinate) (PBSA); Poly(caprolactone) (PCL); Butanediol-terephthalate-adipate terpolymers (PBAT); Cellulose acetate; Poly(vinyl alcohol) (PVOH); poly(vinylacetate-co-vinylalcohol) (PVAc/VA); poly(β-hydroxybutyrate) (PHB); Poly(β-hydroxybutyrate-co.beta.-hydroxyvalerate) (PHBN); poly(β-hydroxyalkanoates) (PHA); Poly(ester amide) (PEA) and other, biodegradable aliphatic polyesters, and aliphatic-aromatic copolyesters.

In another embodiment, the one of the dicarboxylic acid and dicarboxylic acid anhydride is succinic acid, maleic acid, phthalic acid, citric acid and fumaric acid, succinic anhydride, maleic anhydride, phthalic anhydride, citric anhydride or fumaric anhydride.

In another embodiment, the polyol is glycerol, ethylene glycol, polyethylene glycol, propylene glycol, polypropylene glycol, sorbitol, or a combination thereof.

In another embodiment, the starch-resin copolymer is suitable for use in a downstream process in which the copolymer is extruded, moulded, blow-moulded, blown into a film, cast into a film, compression moulded, or vacuum formed.

In another embodiment, the starch copolymer-resin can be used as a hot melt adhesive, coating, or bonding agent.

In another embodiment, the starch-resin copolymer has a Fourier Transform Infrared (FTIR) spectrum of the starch-resin copolymer has double peak between about 2850 and about 3000 cm⁻¹.

In another aspect, there is provided a film comprising the starch-resin copolymer as described.

### BRIEF DESCRIPTION OF THE FIGURES

For a better understanding of the present invention, as well as other aspects and further features thereof, reference is made to the following description which is to be used in conjunction with the accompanying drawings, where:

FIG. 1 shows an FTIR spectrum of a reference material manufactured using the disclosure of Narayan (U.S. Pat. No. 7,985,794);

FIG. 2 shows an FTIR spectrum of a starch-resin copolymer material from Lot 73 produced in accordance with one embodiment of the process presently described;

FIG. 3 shows an FTIR spectrum of a polymer prepared by Narayan U.S. Pat. No. 7,985,794 (bottom) compared to a starch copolymer one embodiment of the process presently described (top);

FIG. 4a shows an FTIR spectrum of: a starch-resin copolymer made in accordance with one embodiment of the present process (top); the polymer Ecoflex™ (PBAT Lot 59726747GO) (middle); and a starch-resin copolymer material produced in accordance with one embodiment of the process presently described (bottom);

FIG. 4b shows an FTIR spectrum of the starch polymer resin prepared by the process of Narayan (top), the polymer Ecoflex™ (PBAT Lot 59726747GO) (middle), and the intermediate chemically modified thermal plastic starch as identified by Narayan (bottom);

FIG. 5 shows an FTIR spectrum of a polymer material produced in accordance with the process of Narayan;

FIG. 6 shows an FTIR spectrum of a polymer material produced in accordance with the one embodiment of the process presently described;

FIGS. 7a and 7b depict the tensile strength measurements taken of films produced using a copolymer produced using the Narayan process;

FIGS. 8a and 8b depict the tensile strength measurements taken of films produced using a starch-resin copolymer produced in one embodiment of the process presently described;

FIGS. 9a and 9b depict the tensile strength measurements taken of films produced using a starch-resin copolymer of the presently described process;

FIGS. 10a and 10b depict the tensile strength measurements taken of films produced using a starch-resin copolymer produced in one embodiment of the process presently described;

FIGS. 11a and 11b depict the tensile strength measurements taken of films produced using a starch-resin copolymer produced in one embodiment of the process presently described;

FIG. 12 graphically depict FTIR spectra of a starch-resin copolymer produced in accordance with one embodiment of the process presently described, with the trace of an LLDPE hexane copolymer (bottom) and an HDPE copolymer (top);

FIG. 13 graphically depicts an FTIR spectra of a starch-resin copolymer produced in accordance with one embodiment of the process presently described;

FIG. 14 is one example of a two-stage extrusion reactor;

FIG. 15 depicts a schematic of a typical process set up for the production of biodegradable products;

FIGS. 16a and 16b depict the tensile strength measurements taken of films produced from a starch-resin copolymer of Example 1;

FIGS. 17a and 17b depict the tensile strength measurements taken of films produced from a starch-resin copolymer of Example 1; and

FIGS. 18a and 18b depict the tensile strength measurements taken of films produced from a starch-resin copolymer of Example 2.

### DETAILED DESCRIPTION

### Definitions

Unless defined otherwise, all technical and scientific terms used herein have the same meaning as commonly understood by one of ordinary skill in the art to which this invention belongs.

As used in the specification and claims, the singular forms “a”, “an” and “the” include plural references unless the context clearly dictates otherwise.

The term “comprising” as used herein will be understood to mean that the list following is non-exhaustive and may or may not include any other additional suitable items, for example one or more further feature(s), component(s) and/or ingredient(s) as appropriate.

Terms of degree such as “substantially”, “about” and “approximately”, as used herein, refer to a reasonable amount of deviation of the modified term such that the end result is not significantly changed. These terms of degree should be construed as including a deviation of at least ±5% of the modified term if this deviation would not negate the meaning of the word it modifies.

As used herein, “alkyl” refers to a linear, branched or cyclic, saturated or unsaturated hydrocarbon group which can be unsubstituted or is optionally substituted with one or more substituent. Examples of saturated straight or branched chain alkyl groups include, but are not limited to, methyl, ethyl, 1-propyl, 2-propyl, 1-butyl, 2-butyl, 2-methyl-1-propyl, 2-methyl-2-propyl, 1-pentyl, 2-pentyl, 3-pentyl, 2-methyl-1-butyl, 3-methyl-1-butyl, 2-methyl-3-butyl, 2,2-dimethyl-1-propyl, 1-hexyl, 2-hexyl, 3-hexyl, 2-methyl-1-pentyl, 3-methyl-1-pentyl, 4-methyl-1-pentyl, 2-methyl-2-pentyl, 3-methyl-2-pentyl, 4-methyl-2-pentyl, 2,2-dimethyl-1-butyl, 3,3-dimethyl-1-butyl and 2-ethyl-1-butyl, 1-heptyl and 1-octyl. As used herein the term “alkyl” encompasses cyclic alkyls, or cycloalkyl groups. The term “cycloalkyl” as used herein refers to a non-aromatic, saturated monocyclic, bicyclic or tricyclic hydrocarbon ring system containing at least 3 carbon atoms. Examples of C₃-C₁₂ cycloalkyl groups include, but are not limited to, cyclopropyl, cyclobutyl, cyclopentyl, cyclohexyl, cycloheptyl, cyclooctyl, norbornyl, adamantyl, bicyclo[2.2.2]oct-2-enyl, and bicyclo[2.2.2]octyl.

As used herein, the term “alkenyl” refers to a straight, branched or cyclic hydrocarbon group containing at least one double bond which can be unsubstituted or optionally substituted with one or more substituents.

As used herein, “alkynyl” refers to an unsaturated, straight or branched chain hydrocarbon group containing at least one triple bond which can be unsubstituted or optionally substituted with one or more substituents.

As used herein, “allenyl” refers to a straight or branched chain hydrocarbon group containing a carbon atom connected by double bonds to two other carbon atoms, which can be unsubstituted or optionally substituted with one or more substituents.

As used herein, “aryl” refers to hydrocarbons derived from benzene or a benzene derivative that are unsaturated aromatic carbocyclic groups of from 6 to 100 carbon atoms. The aryls may have a single or multiple rings. The term “aryl” as used herein also includes substituted aryls. Examples include, but are not limited to phenyl, naphthyl, xylene, phenylethyl, substituted phenyl, substituted naphthyl, substituted xylene, substituted phenylethane and the like.

As used herein, “substituted” refers to the structure having one or more substituents. A substituent is an atom or group of bonded atoms that can be considered to have replaced one or more hydrogen atoms attached to a parent molecular entity. Examples of substituents include aliphatic groups such as alkyl, halogen, arylcarbonyloxy, alkoxycarbonyloxy, aryloxycarbonyloxy, alkoxycarbonyl, aminocarbonyl, alkylthiocarbonyl, alkoxyl, cyano, amino, tertiary acylamino, amide, imino, alkylthio, arylthio, sulfonato, sulfamoyl, tertiary sulfonamido, nitrile, trifluoromethyl, heterocyclyl, aromatic, and heteroaromatic moieties, ether, ester, and silicon-containing moieties.

As used herein, “resin” and “polymer resin” refers to any polymer which is useful for copolymer compounding. Polymer resins as presently used can include polyesters or hydrocarbon-based polymers. Preferable polymers are biodegradable and/or compostable, however any polymer that may be combined with a modified starch may be used. Some examples of polyesters include: Poly(lactic acid) or polylactide (PLA); poly(glycolic acid) or polyglycolide (PGA); Poly(hydroxyester ether) (PHEE); Adipic acid-diglycidyl ether of Bisphenol A; Poly(hydroxybutyrate-co-valerate); Poly(butylene-succinate) (PBSA); Poly(caprolactone) (PCL); Butanediol-terephthalate-adipate terpolymers (PBAT); Cellulose acetate; Poly(vinyl alcohol) (PVOH); poly(vinylacetate-co-vinylalcohol) (PVAc/VA); poly(β-hydroxybutyrate) (PHB); Poly(β-hydroxybutyrate-co.beta.-hydroxyvalerate) (PHBN); poly(β-hydroxyalkanoates) (PHA); Poly(ester amide) (PEA) and other, biodegradable aliphatic polyesters, and aliphatic-aromatic copolyesters. Some examples of petrochemical or hydrocarbon based polymers include polyolefin resins such as polyethylene and polypropylene.

As used herein, “starch” refers to a carbohydrate or polysaccharide consisting of a large number of glucose units joined together by glycosidic bonds. Starch used in the processes described may be derived from, for example, potatoes, grains, wheat, maize, corn, rice, tapioca, or cassava. This term also includes also any derivatives of amylose and/or amylose pectin and may include derivatives of the various these starches through chemical modification and substitution thereof. Examples of other treatments producing modified starch include but are not limited to: dextrin roasted starch with hydrochloric acid; alkaline-modified starch with sodium hydroxide or potassium hydroxide; bleached starch with hydrogen peroxide; oxidized starch with sodium hypochlorite, breaking down viscosity; enzyme-treated starch maltodextrin or cyclodextrin; monostarch phosphate with phosphorous acid or the salts sodium phosphate, potassium phosphate, or sodium triphosphate to reduce retrogradation; distarch phosphate by esterification with for example sodium trimetaphosphate, crosslinked starch modifying the rheology and/or the texture; acetylated starch esterification with acetic anhydride; hydroxypropylated starch (such as E1440), starch ether, with propylene oxide, increasing viscosity stability; hydroxyethyl starch, with ethylene oxide; octenyl succinic anhydride (OSA) starch used as emulsifier adding hydrophobicity; and cationic starch, adding positive electrical charge to starch carboxymethylated starch with monochloroacetic acid adding negative charge.

As used herein, the term “polyol” or “polyhydroxyl” or “polyhydric alcohol” refers to an organic materials having at least one hydroxyl group. These terms also include alcohols having two hydroxyl groups, such as, for example ethylene glycol, propylene glycol, or three hydroxyls such as, for example, glycerol. Other polyols can have multiple hydroxyl groups such as, for example, polymers of glycerol, and sugars such as sorbitol. The term “polyol” can also include a combination of these compounds. Some preferred examples of polyols are glycerol, ethylene glycol, polyethylene glycol, propylene glycol, polypropylene glycol, sorbitol, monosaccharides and mixtures thereof. One function of the polyol is to plasticize the starch, enhancing the mechanical properties of the resulting polymer.

As used herein, the term “dicarboxylic acid anhydride” refers to any organic material having at least one anhydride functionality. Some examples of dicarboxylic acid anhydrides that may be used in the presently described process are dibasic acids and/or their anhydrides but not limited succinic anhydride, maleic anhydride, phthalic anhydride, furmaric anhydride, citric acid anhydride. One preferred dicarboxylic acid anhydride is maleic anhydride. As used herein, the term “dicarboxylic acid” refers to any organic compound having at least two carboxylic acid (—COOH) functionalities therein. Some preferred examples of dicarboxylic acids that may be used in the presently described process are succinic acid, maleic acid, phthalic acid, citric acid and fumaric acid. One example of a preferable dicarboxylic acid is maleic acid. One preferred dicarboxylic acid anhydride is maleic anhydride. Dicarboxylic acids or dicarboxylic acid anhydrides useful in the present process may include for example, without being limited to, alkyl, aryl, or any substituted organic molecule which has at least two carboxylic acid groups and the number of carbon atoms between the two carboxylic acid carbon atoms is from 2 to about 26. Dicarboxylic acid anhydrides wherein the at least two carboxylic acids form an anhydride may be also be useful in the present processes.

The present application provides and alternative process for the manufacture of starch-resin copolymers which makes use of a starch having a low moisture content. This process of making a starch-resin copolymer as described herein can result in less degradation to the starch than some other processes for making starch copolymers. By reducing degradation during the process, the resultant copolymers can be less discoloured than compositions prepared using other processes. The process of making a starch-resin copolymer as described can also result in polymers having an improved tensile strength.

The presently described starch-resin copolymers have a wide variety of uses and can be used in a broad range of processing methods. Some specific examples of processes in which the present starch-resin copolymer can be used are in the manufacturing of extruded products, moulded products, blow moulded products, blow or cast films products, compression moulded products and vacuum formed products.

Specific uses for the presently described starch-resin copolymers is in the manufacture of injection moulded consumer goods. Examples of these include but are not limited to: bowls, plates, toys, tooth brushes/handles. Other specific uses include the manufacturing of blow moulded consumer goods such as bottles for products like shampoos and detergents. Other specific uses include the manufacturing of vacuum formed applications including but not limited to coffee cup lids, creamer containers, and containers for yogurt, sour cream, etc.

The present starch-resin copolymers also find uses in the manufacturing of short life, single use materials or products, and products that biodegrade subsequent to use. Examples of these include but are not limited to: films for use in bags, wraps and bubble wrap; sandwich wrap films and papers; packaging goods, such as, but not limited to, clam shell containers, bowls and plates; disposable cutlery such as knives, forks, and spoons, garbage bags, shopping bags, garment or “T” shirt bags.

The present starch-resin copolymers can also be used as hot melt adhesives for laminated applications. Laminating processes are used widely in the manufacture of commercial goods, and vary widely in the types of materials that can be used. Some non-limiting examples of laminating processes for which the present polymers can be used are: laminating plastics of different material together; laminating layers of paper together; inner or outer barrier application in corrugated or kraft or box board or paper materials development; laminating wood together for laminated wood products and/or particle board for various applications; and as a film laminated to paper for coffee cup or other beverage container applications.

To gain a better understanding of the invention described herein, the following examples are set forth. It should be understood that these examples are for illustrative purposes only. Therefore, they should not limit the scope of this invention in any way.

### EXAMPLES

### Example 1

### General Process

Raw materials for producing the exemplary starch-resin copolymers were obtained from a variety of suppliers. The starch was obtained from Tate & Lyle, Ingredion, Pennford, Grain Processing Corporation and Archer Daniels Midland. Maleic anhydride was obtained from Repsol, Canada Colors and Chemicals Limited or Brenntag. Glycerol was obtained from Dow, Brenntag and Procter & Gamble. The water used in the below examples was standard tap water in the inventor's facility in Newmarket, Ontario, Canada. Peroxide was obtained from Arkema Inc. or Akzo Nobel. Polyester was obtained from Samsung in Korea or BASF AG. A Littleford™ FKM 600D 2Z Littleford Day FKM Reactor/Drier batch reactor was used in the following examples. In a batch process, a suitable reactor preferably has the ability to constantly turn material over and draw a vacuum.

General Process

Starch is prepared in a batch process, such as in a Littleford™ FKM 600D 2Z Littleford Day FKM Reactor/Drier. Because of presence of hydroxyl groups, starch has a tendency to hold on to free water. The moisture level of the initial starch starting material is normally between 9-12% water. It is preferable to remove some of the water from the starch to allow the free hydroxyl groups of the starch to be available for reaction with the dicarboxylic acid or dicarboxylic acid anhydride (as is described below). The starch starting material can be dried under vacuum with relatively mild heating. The vacuum enables the removal of water of hydration on the starch at lower temperature so as not to break-down the starch, which can result in caramelization and discolouration. Sample conditions are vacuum drawn to 5 to 20 inches of Hg below atmospheric pressure and temperatures between about 140-280° F. (60-160° C.).

The starch or modified starch should be at a moisture level of not greater than about 8% wt. Preferably, the starch or modified starch should be at a moisture level of not greater than about 5% wt, and most preferably 3% wt moisture content. Once an appropriate moisture level is obtained, the starch or modified starch is ready for functionalization via esterification.

Esterification can be carried out in a batch process in a batch reactor. A dicarboxylic acid or dicarboxylic acid anhydride is introduced to the starch. The amount of dicarboxylic acid added to the reactor is preferably from about 0.25-15% wt. A more preferable amount of the dicarboxylic acid or dicarboxylic acid anhydride is from 0.25 to 3% wt.

In stage 1, the dicarboxylic acid or dicarboxylic acid anhydride is admixed with the starch. In one specific example, maleic anhydride (MAH) powder is admixed with dry starch and the admixture is tumbled for about 15 minutes to uniformly disperse the MAH throughout the starch. In this embodiment, during this process, the temperature is maintained between 120° F.-280° F. (48.9-160° C.) to assist the MAH in melting over and/or coating the surface of the starch and/or react with the starch. In this embodiment, moisture levels are maintained low enough to prevent further reaction of the MAH.

In stage 2, once the dicarboxylic acid or dicarboxylic acid anhydride/starch powder is admixed, a liquid mixture is sprayed or atomized over the powder admixture. The liquid mixture has an aqueous polyol, such as, for example, glycerol. The liquid mixture may also comprise, for example, an initiator. The most widely used initiators produce free radicals (reactive atoms or groups of atoms that contain odd numbers of electrons). Some examples of initiators include peroxides, acids and aliphatic azo compounds, organometallic compounds and metallic halides. Preferred peroxides are organic peroxides. The role of the initiator is to speed up the rate of reaction, effect the mechanism of the reaction, enhance the mechanism of the reaction, or a combination of these. In the absence of initiator the reaction may still occur, however most likely at a slower rate. Generally, the polyol reacts with the initiator to functionalize the starch. The polyol may provide pliability to the resulting thermoplastic.

As the liquid mixture is added to the reactor, the vessel temperature may increase. The elevation in temperature is indicative of the presence of a chemical reaction as the esterification reaction is exothermic. Once the liquid mixture is added to the powder, the mixture is allowed to tumble until the temperature ceases to rise. The functionalized starch can be obtained by controlling the rate and temperature of reaction. After the reaction is complete, a sample of the mixture is then extracted to assess the moisture level.

The material is then dried to a moisture level of preferably not greater than about 3% wt. More preferably, the material is dried to a moisture level of not greater than about 1% wt. This can be accomplished under vacuum with mild heating in, for example, a batch reactor such as a Littleford, or in a Kneader Internal Mixer. Sample conditions include vacuum drawn to between about 5 to 20 inches of Hg below atmospheric and temperatures of between about 140-280° F. The stronger the vacuum, the lower the processing temperature required to dry the material. As such, if more vacuum is employed during drying, lower temperatures are required to obtain the same desired low moisture level.

Table 1 exemplifies the compositional ranges of raw materials by reaction stage. Table 2 provides an exemplary formulation including the amounts of material at each stage.

TABLE 1
Compositional Formulation

| Raw material | Stage 1 | Stage 2 | Stage 3 |
|---|---|---|---|
| Starch | 85-99.8% | 65-85% | 40-60% |
| MAH | 0.2-15.0% | | |
| Glycerol | | 10-25% | |
| Water | | 4-12% | |
| Peroxide | | 0-0.3% | |
| Polyester | | | 40-60% |
| Total | 100% | 100% | 100% |

TABLE 2
Exemplary Formulation

| Raw material | Stage 1 | Stage 2 | Stage 3 |
|---|---|---|---|
| Starch | 98.37% | 76.63% | 45% |
| MAH | 1.63% | | |
| Glycerol | | 16.60% | |
| Water | | 6.67% | |
| Peroxide | | 0.1% | |
| Polyester | | | 55% |
| Total | 100% | 100% | 100% |

The combination of the batch process as described as well as the drying methods used in combination with the batch process can result in the final material having less discolouration than materials produced using other methods, such as reactive extrusion methods. Specifically, as a result of the reaction conditions, the polymer materials and starches in the presently described process may be less prone to caramelization or browning, as well as degradation or side reactions that may occur at high temperatures and pressures. Accordingly, the resulting starch-resin copolymer products may be whiter in colour, and may have better colour stability.

In addition, the use of high vacuum levels and moderate temperatures can result in dramatically reduced cycle times for drying. The drying methods described which employ high vacuum and low temperatures may achieve the same moisture level in minutes compared to hours or days that are achieved using other conventional methods. This may result in time and energy savings, as well as general optimization of the process.

Once the desired moisture level is achieved in the drying process, the material can be mixed with at least one other polymer resin. This may be carried out in a batch process in a standard batch reactor such as those previously described. The resin material is weighed out for introduction to functionalized starch, and mixed until it has obtained a dough-like consistency. Preferably, the resin is biodegradable if a biodegradable product is desired. Some preferable resins are biodegradable polyester resins such as poly(butylene adipate-co-terephthalate) (PBAT), polylactic acid (PLA), poly(butylene-succinate), poly(hydroxybutyrate-co-valerate), poly(caprolactone), aromatic and aliphatic co-polyester biobased and biodegradable or polyolefin.

During this mixing, controlling the temperature may protect the materials from degradation and loss of properties. Preferred are temperatures of between about 140-230° F. Temperatures over 230° F. may gelatinize the starch material. Moisture levels may also maintained low so that the thermal plastic starch does not degrade the resin or the product during compounding.

The final material is removed from the batch reactor and may be further processed prior to use in forming. Pelletization can then carried out, for example on a continuous process in an extruder. A Kneader Die Face strain cutter pelletization unit may be used for pelletization. During pelletization, the material is conveyed to a unit that forces the dough through a die plate to make strands or pellets of biodegradable plastics. Strands in varying length and shape can be made to suit the desired application. The starch-resin copolymer can be solvent cast, melt cast or blown into clear films particularly for use in single use disposable applications and can be biodegradable.

Characterization of Starch-Resin Copolymers

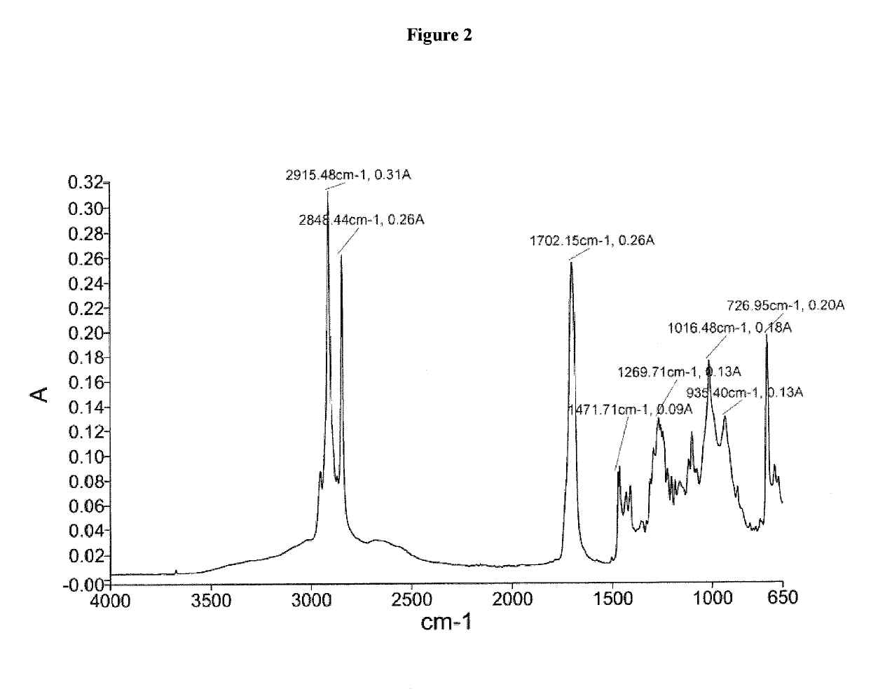

The materials produced in accordance with the presently described methods can be analysed using FTIR spectroscopy. The spectra shown were obtained using a Perkin-Elmer Spotlight 400 FTIR Imaging System. FIG. 2 shows the FTIR spectrum of Lot 73 of a polymer produced by the present process.

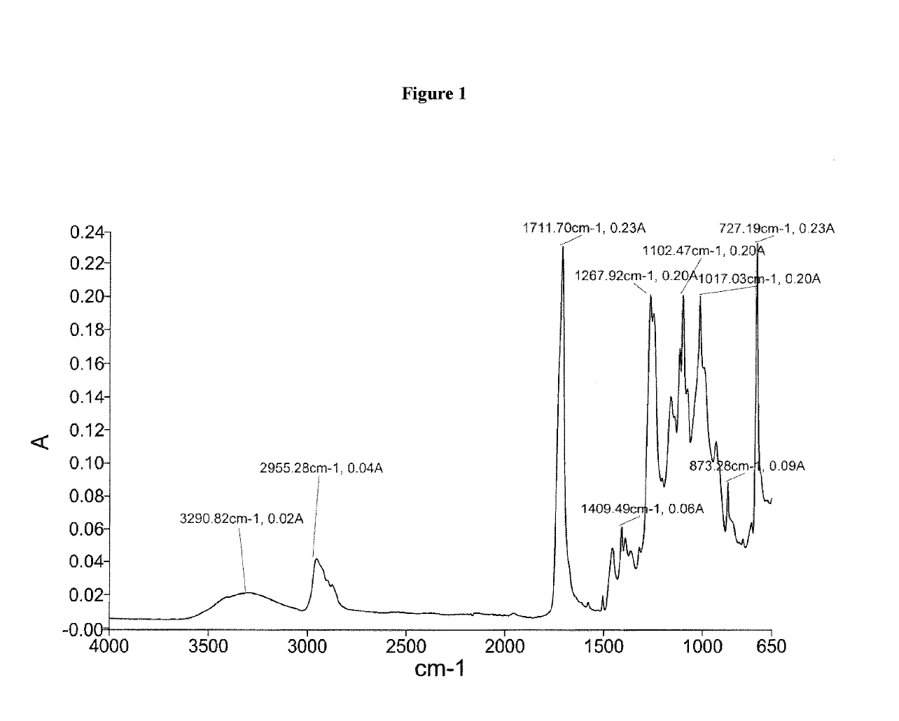

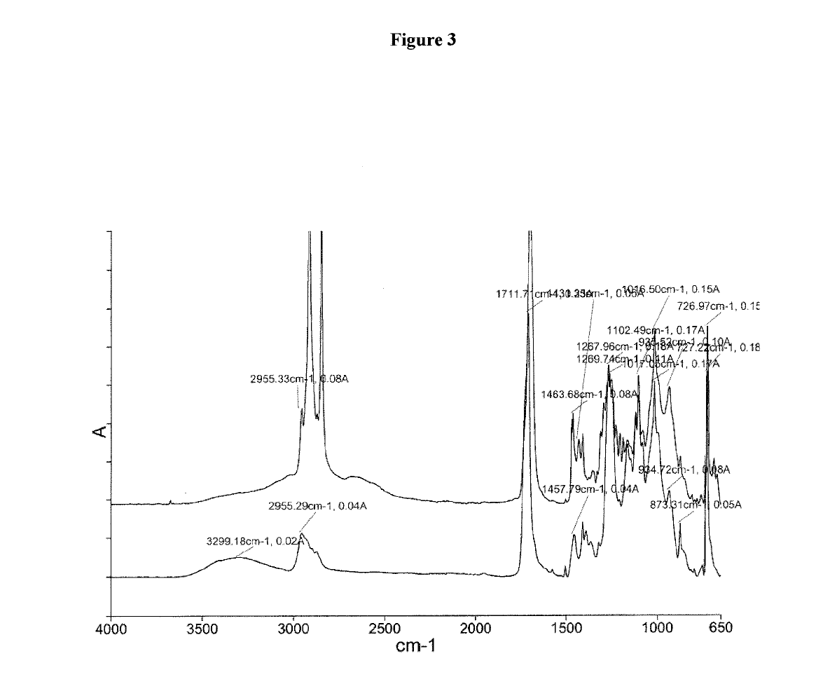

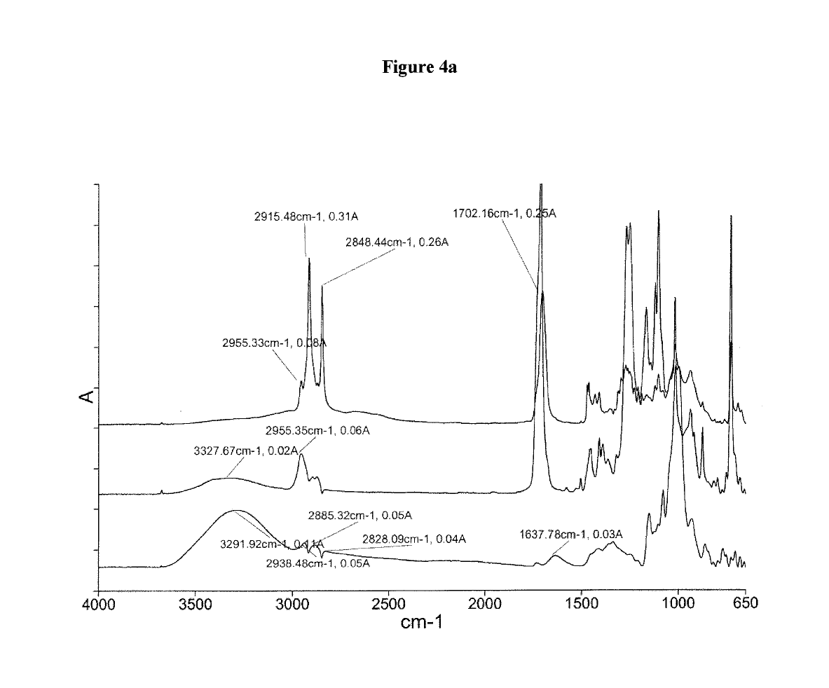

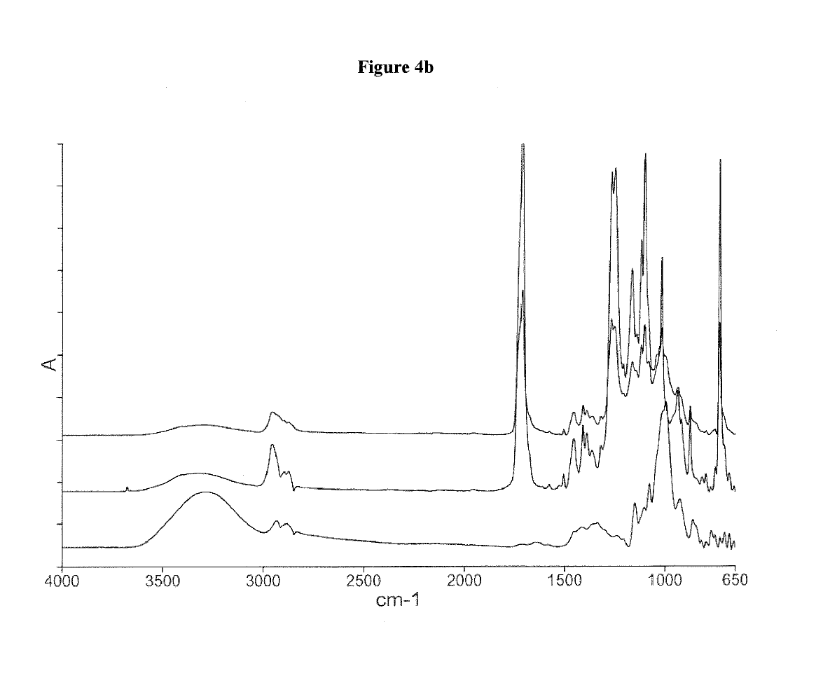

Starch polymers were prepared according to the process described by Narayan. The intermediates and products of these reactions were also characterized and are shown in FIGS. 1 and 2 to 4b. FIG. 1 graphically depicts an FTIR spectrum of a reference material manufactured using the disclosure of Narayan (U.S. Pat. No. 7,985,794). FIG. 3 graphically depicts an FTIR spectrum of a polymer prepared by Narayan U.S. Pat. No. 7,985,794 (bottom) compared to a starch copolymer of Narayan (top). FIG. 4a graphically depicts an FTIR spectrum of: a chemically modified thermal plastic starch made in accordance with one embodiment of the present process (top); the commercial polymer Ecoflex™ (PBAT Lot 59726747GO) (middle); and a starch-resin copolymer material produced in accordance with one embodiment of the process presently described (bottom). FIG. 4b graphically depicts an FTIR spectrum of the starch polymer resin prepared by the process of Narayan (top), the commercial polymer Ecoflex™ (PBAT Lot 59726747GO) (middle), and the intermediate functionalized thermal plastic starch as identified by Narayan (bottom).

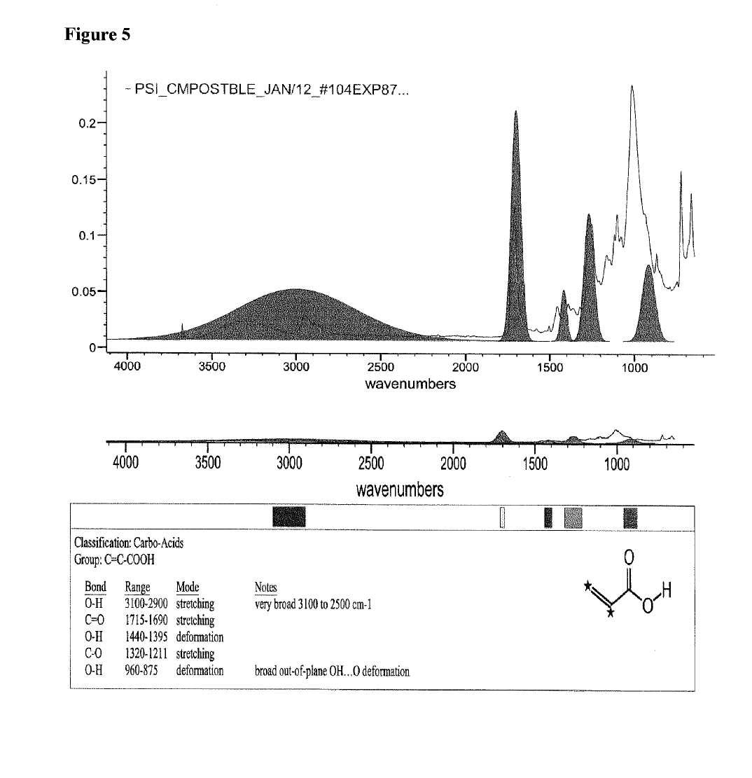

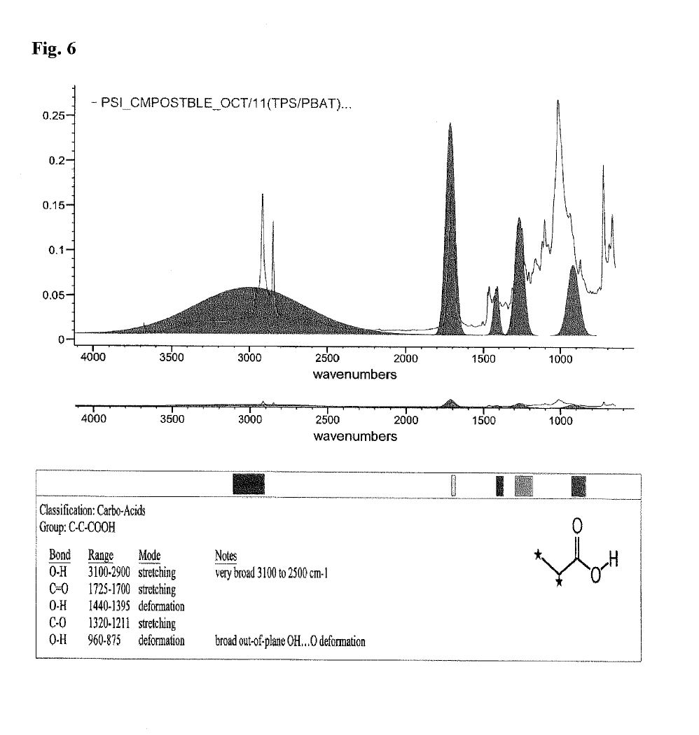

FIG. 5 depicts a polymer obtained using the process of Narayan. In comparison, FIG. 6 is a polymer prepared in accordance with one embodiment of the presently described process, with peaks assigned based on functional groups in the composition. The two new peaks at 2915 & 2848 cm⁻¹ shown in FIG. 6 are indicative of bonding in the present starch-resin copolymer, and seem to play a great role in the bond between the starch and polyester. Also present in the starch-resin copolymer are C═O bonds as observed with the spectra signature at 1700-1710 cm⁻¹. This bonding may also observed in the dramatic differences in physical properties as noted in a side-by-side comparison.

A similar FTIR graph that was reported by C. M. Xiao et al. (2010 Polymer Letters Vol. 4, No. 1, pp. 9-16) for his studies of starch MAH reactions. Xiao et al. refers to esterification as one of the most important methods to synthesize starch-based polymers. The FTIR spectra disclosed by Xiao et al. are of polymerized starch in the presence of MAH. The absence of the strong broad C—OH band at 2500-3200 cm⁻¹ in the polymers produced using the present processes indicate a different chemistry, and therefore a different material altogether.

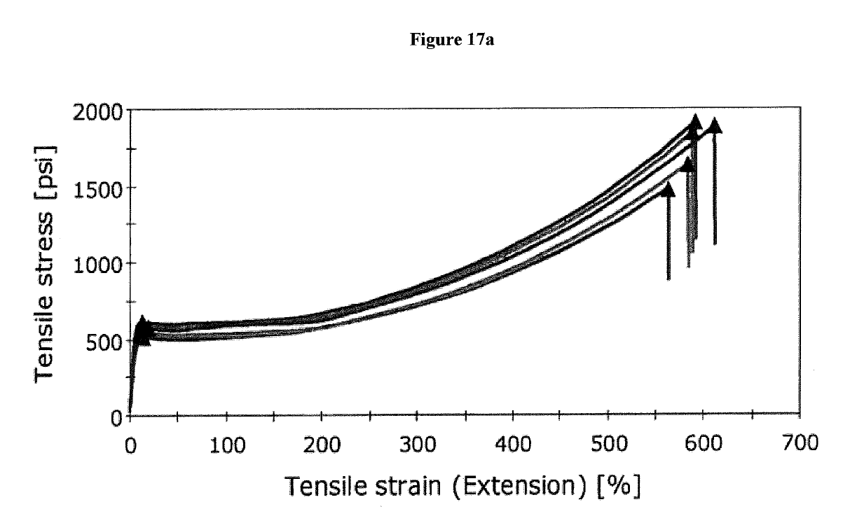

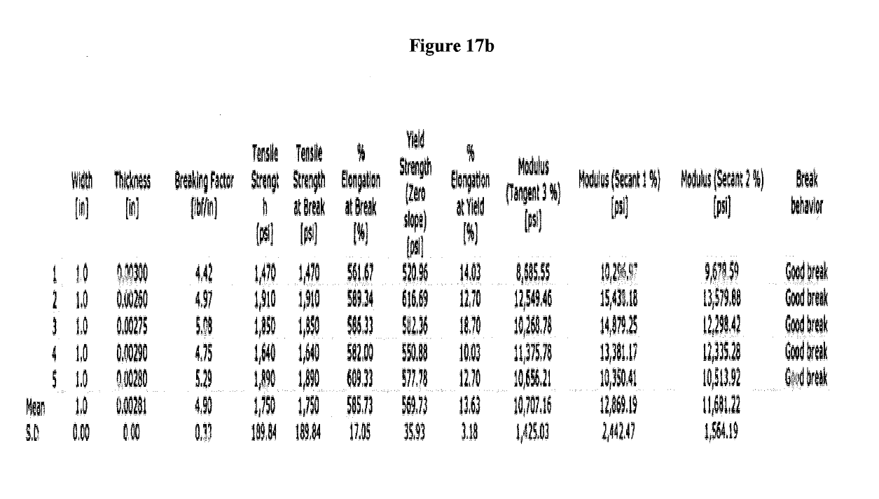

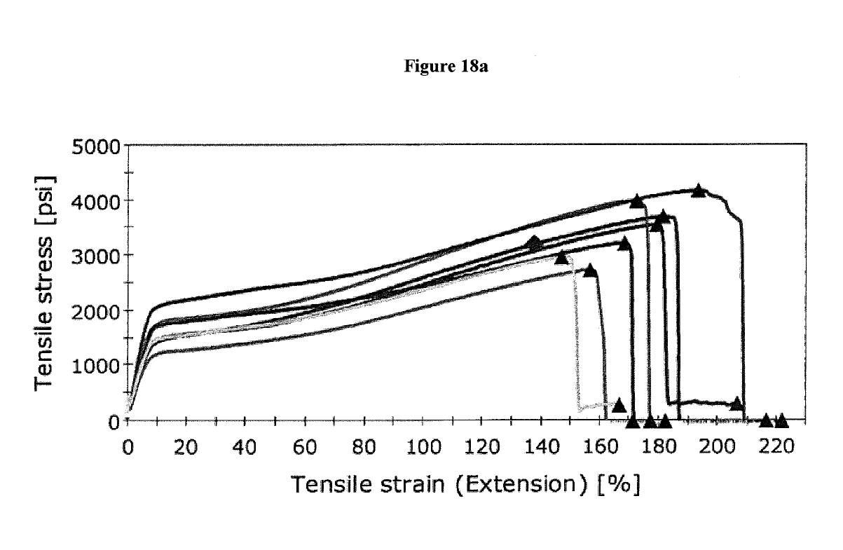

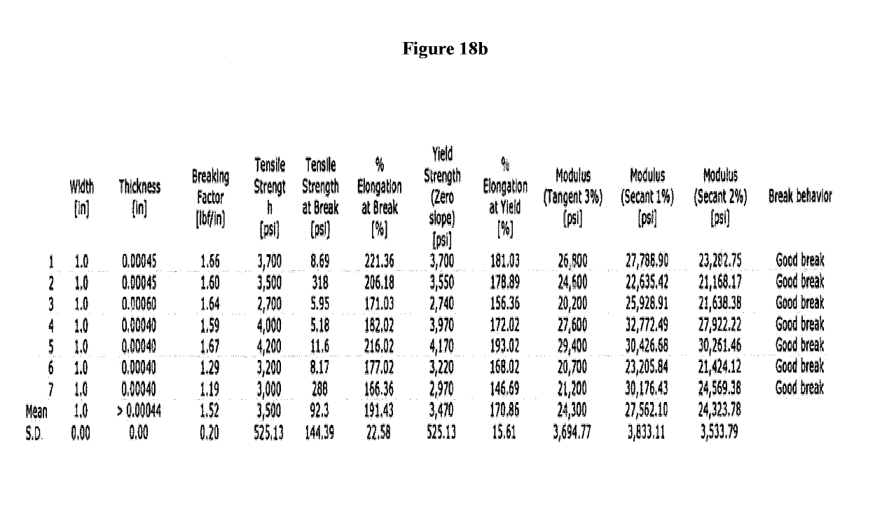

As can be observed in FIG. 17, the size of the FTIR peak in the area of 3200-3400 cm⁻¹ in the present polymer (top) is much smaller than that shown in Narayan (U.S. Pat. No. 7,985,794) (bottom), indicating the potential of a higher degree of substitution of the present polymers as a result of a potential chemical reaction created by condensation and/or etherification and/or esterification of the —OH (hydroxyl group). The strength of the alkylene methyl group (based on C—H stretching) peaks at 2915 and 2848 cm⁻¹ as well the strength of the C═O peak at 1700 cm⁻¹ also identify the present starch-resin copolymers as different from those previously described.

Starch-Resin Copolymer Properties

Starch-resin copolymers produced in accordance with the processes described may be less discoloured than similar polymers produced using other processes. The described processes can control and/or avoid degradation and/or caramelization of the raw materials (for example, the starch) as well as the functionalized starch and the starch-resin copolymer products during processing. The resulting starch-resin copolymer products may have improved visual and colour properties, such as less of the brown hues that result from chemical degradation of the starch.

The present process can generate a white to just off white pellet, compared to the manila to dark amber pellets produced by reaction extrusion processes using the same or similar starting materials. Measurements for colour of a final product were obtained on a BYK colorimeter, and the data is shown in Table 3, below.

TABLE 3
Colour numbers for Lot 73:

| Colour Property | Range |
|---|---|
| L* | 80.30-81.93 |
| a* | 0.56-0.66 |
| b* | 6.47-11.23 |

Polymer films were produced using the starch-resin copolymers prepared by the presently described processes. Tensile measurements taken using an Instron instrument using a standard test method for testing tensile properties of thin plastic sheeting as set out in ASTM D 882-09. The preparation method used was ASTM Practice D6287 and the conditioning procedure used was ASTM D618-08. The test was carried out under test conditions of 23+/−2° C. and 50+/−10% relative humidity (RH). Tests were carried out on rectangular sheets of 1.0 inches width and 0.0035 inches thickness and a length of 150 mm and a gauge length of 50 mm. The grip type was 2.5 mm×2.5 mm Square, rubber covered.

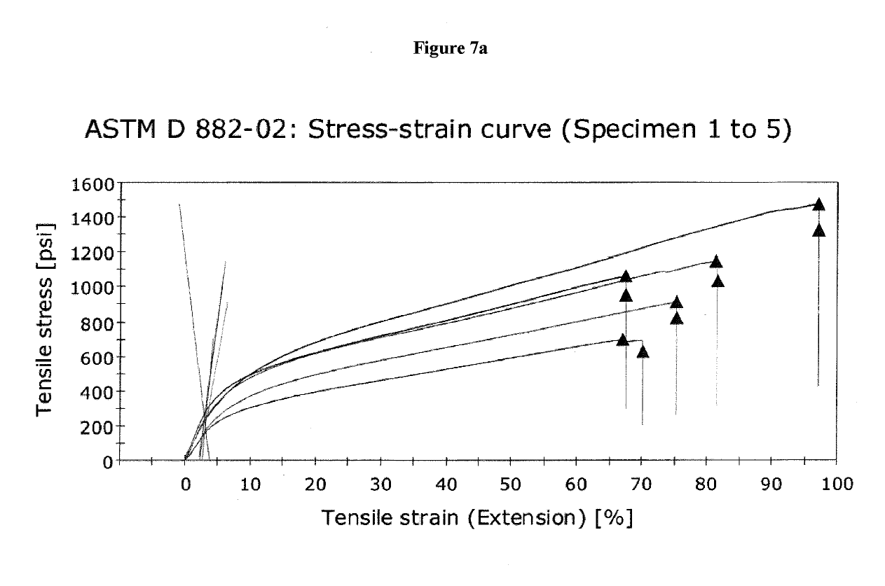

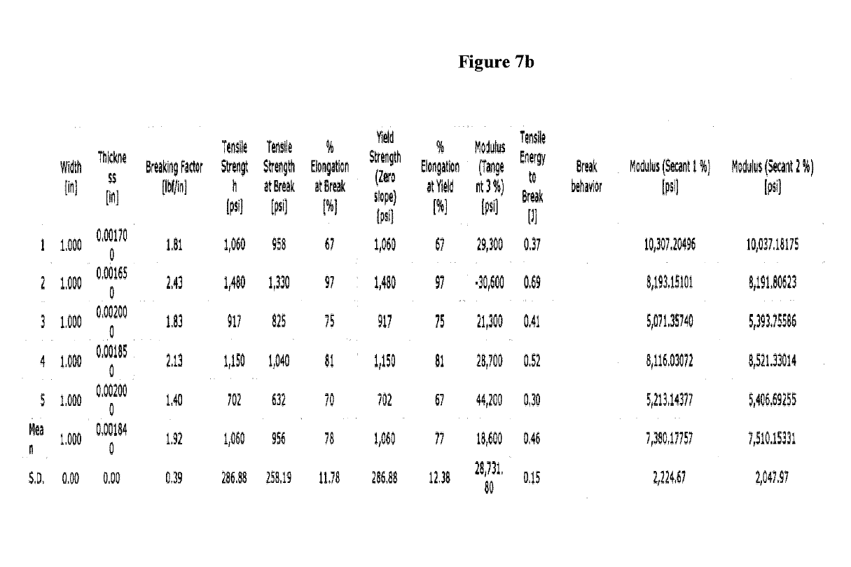

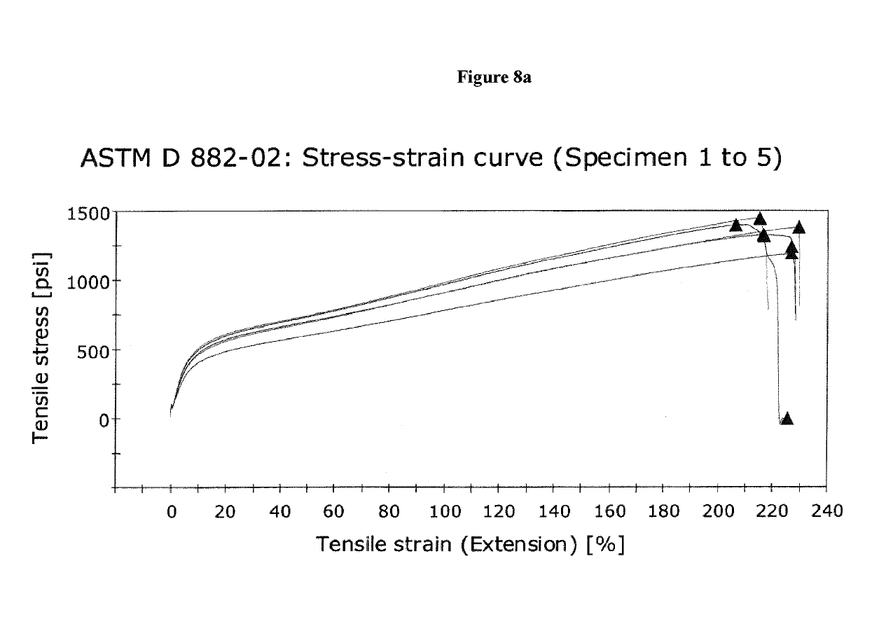

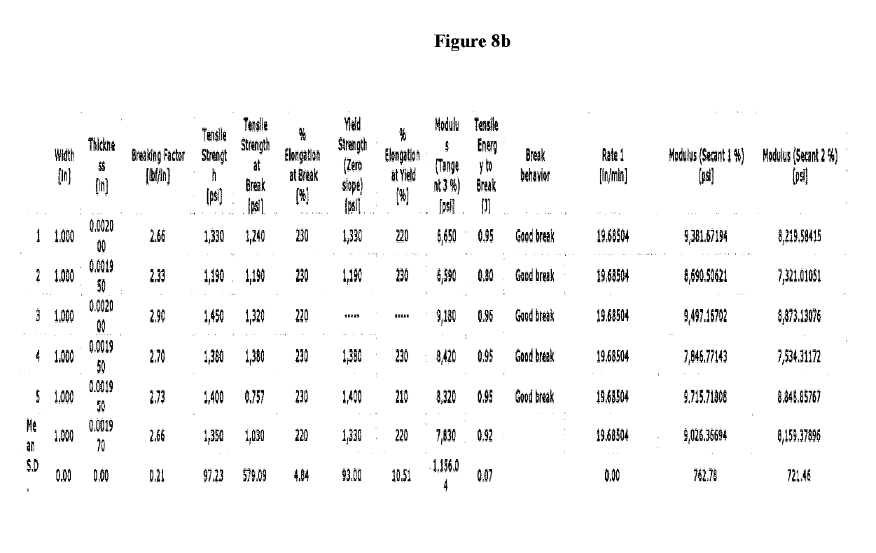

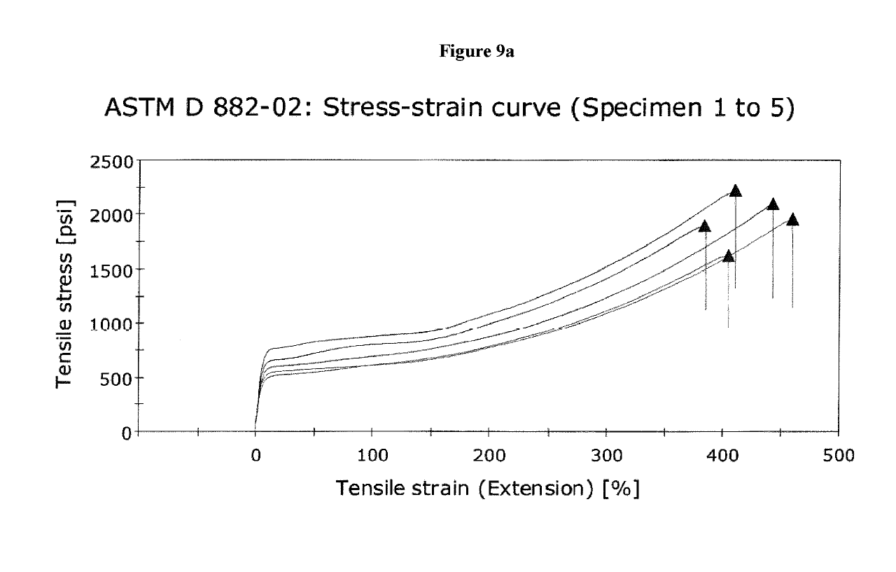

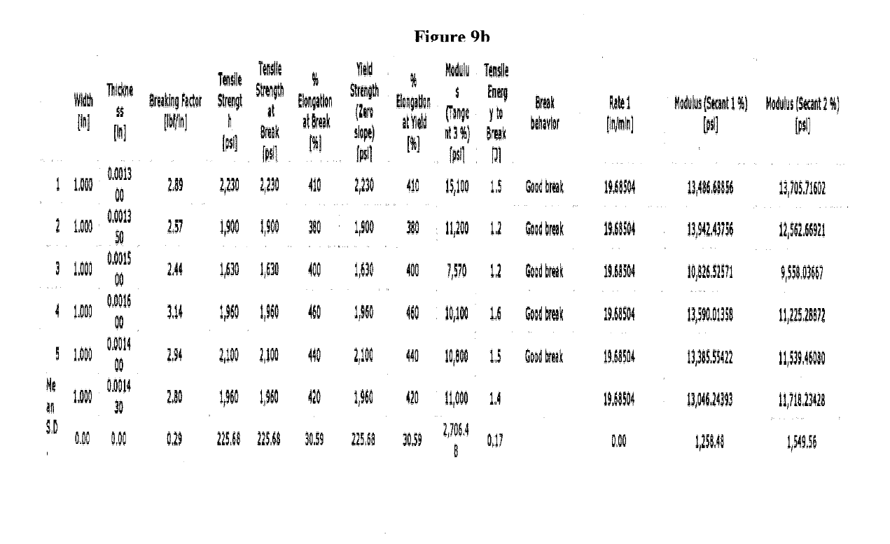

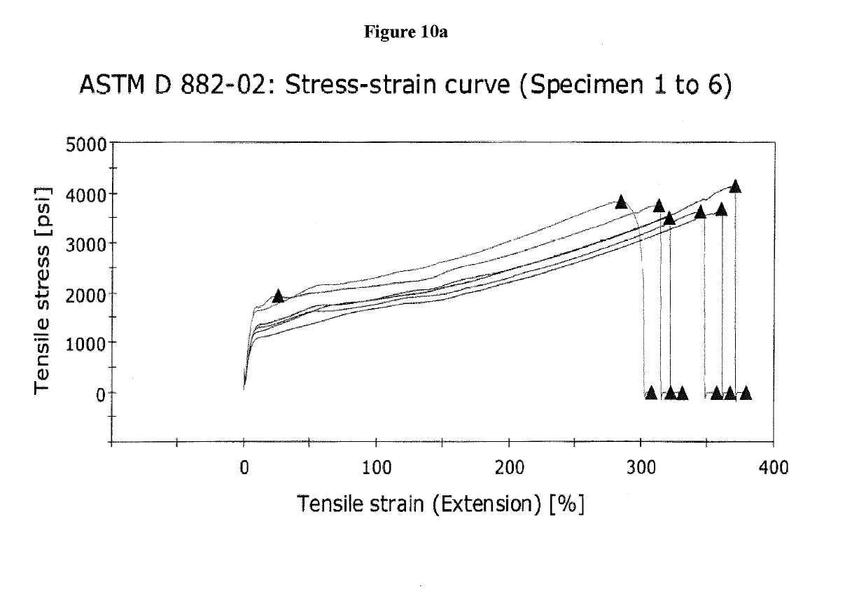

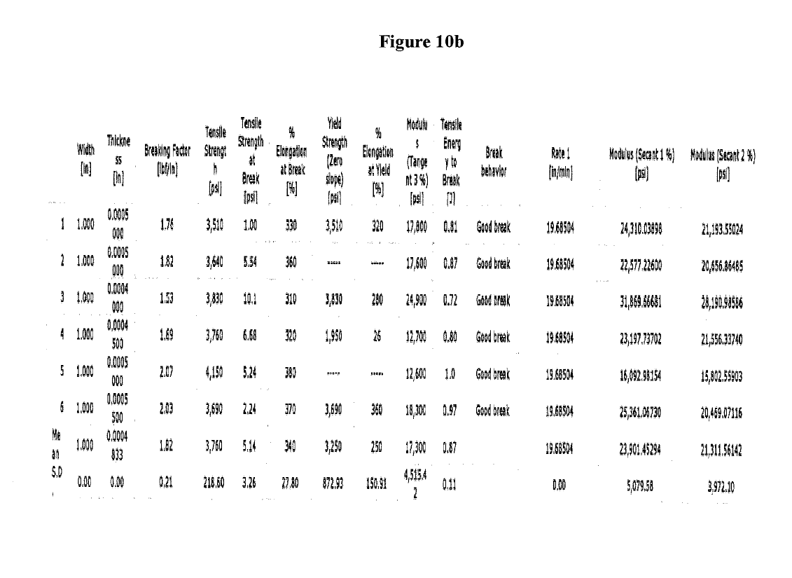

FIGS. 7-11 depict the tensile strength measurements taken of films produced using the products of the presently described processes. Specifically, the tensile properties of these films were measured. A summary of these measurements and film characteristics is shown in Table 4 below. Machine direction is denoted as ‘MD’ and transverse direction is denoted as ‘TD’.

TABLE 4
Film characteristics

| | | |
|---|---|---|
| | Lot 73 - PSI | Lot 104 - reference |
| Characteristic | production | material |

| Tensile Strength | 1,300 psi-9,000 psi | 946 | psi |
|---|---|---|---|
| Elongation (MD, %) | 190-300 | 78 | |
| Elongation (TD, %) | 190-400 | — | |
| Tear (MD) | 130-260 gf | 145 | gf |
| Tear (TD) | 140-290 gf | 70.4 | gf |

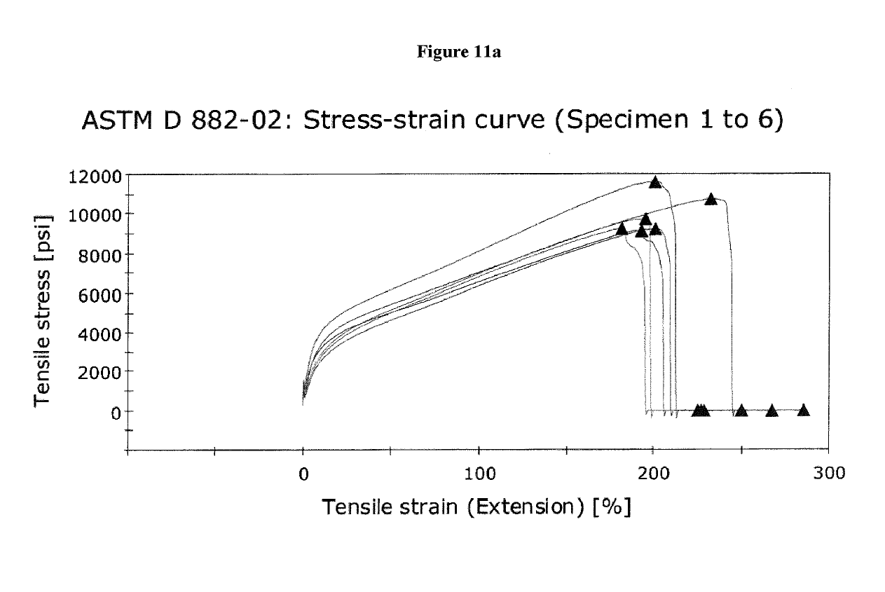

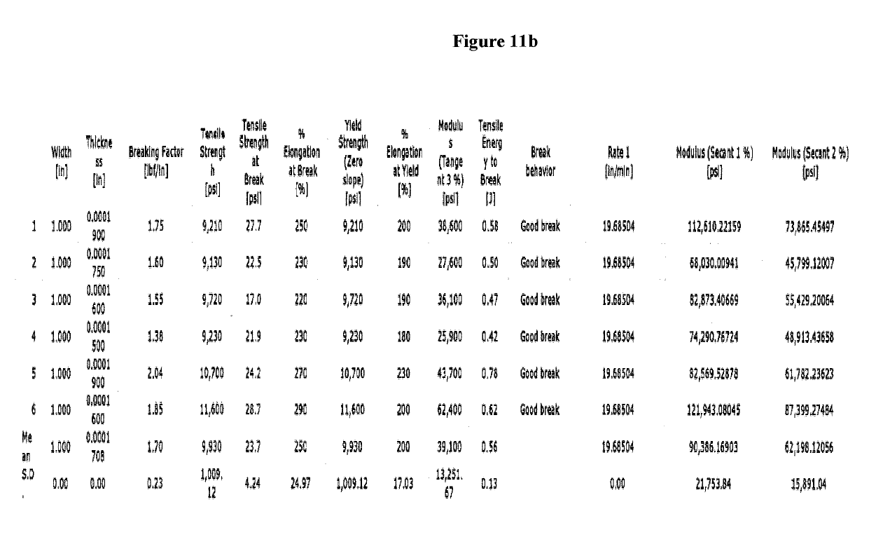

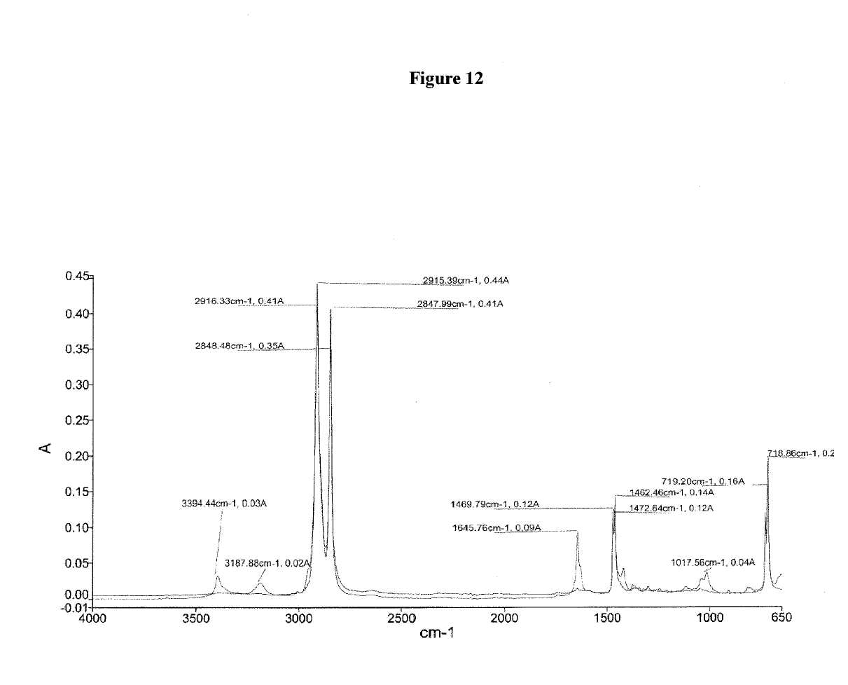

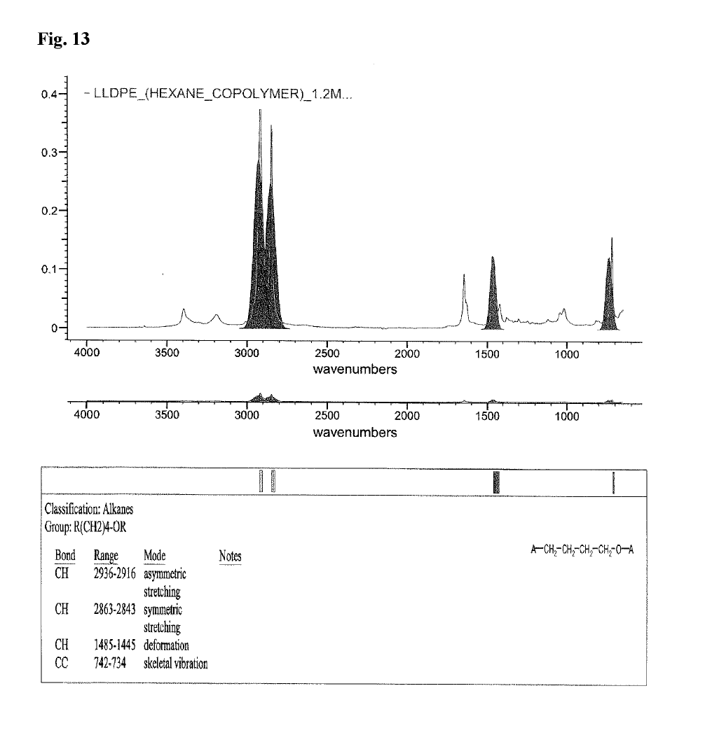

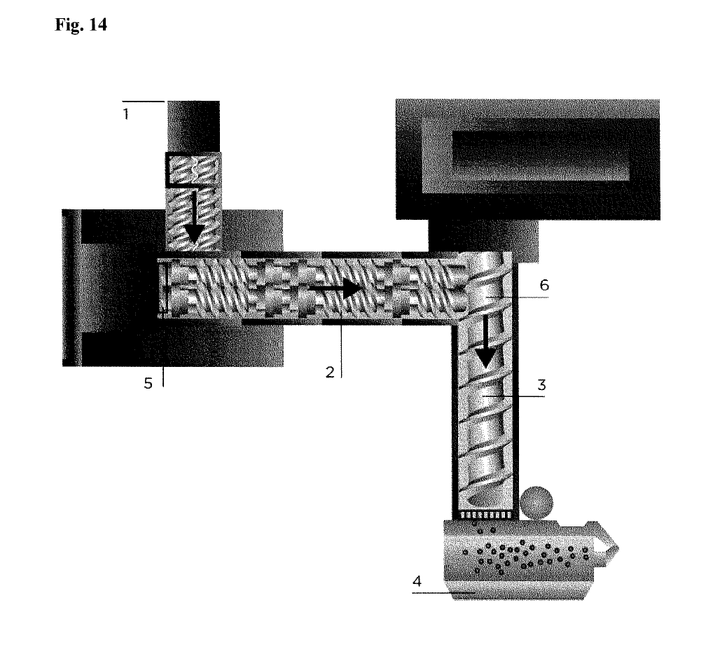

It was observed that the thinner films generated higher tensile valves with marginal losses in elongation. One material shown as measured in FIG. 11 was notable. This material exhibited very high tensile numbers and elongation for the extremely thin characteristic of the film.

### Example 2

### Batch Reactor Processes

Exemplary Batch Reactor Process—1

In the following process, the starch was obtained from Ingredion. Maleic anhydride was obtained from Brenntag as maleic anhydride brickets. Glycerol (99.9%) pure) was obtained from Brenntag. The water used in the presently described processes was standard tap water in the inventor's facility in Newmarket, Ontario, Canada. Peroxide was obtained from Arkema Inc. as Luperox™ 101. Polyester was obtained from BASF AG as Ecoflex™ FB1200.

In a 600 litre reactor, 136 kg of Starch at 170° F. (76.7° C.) was dried down to a moisture content of 2.6% under vacuum of 12.5 inches of Hg below atmospheric pressure. To accelerate the drying process, dry nitrogen was added to the Littleford reactor. It has been found that the closer the temperature of the nitrogen gas that enters the reactor, the faster the rate of drying of the material. Air and Nitrogen in its dry state is known to absorb moisture, and can assist by absorbing excess moisture in the reaction. MAH brickets were ground to a fine powder and introduced into the dry starch under continuous agitation for a period of 15 minutes. During that period an 8° F. increase in temperature of the starch was observed, following which a mixture of glycerol, water and peroxide was sprayed on to the starch/MAH mixture. Once again, a temperature rise was noted in the reactor; the material temperature increased 17° F. to 198° F. within 17 minutes. Vacuum was re-initialized and the mixture was drawn down to 2.2% moisture. At that point the material was emptied from the Littleford reactor and weighted up for compounding with the polyester. The starch-resin copolymer was white in colour, dry to the touch, and easy to form a ball under slight pressure. The final moisture of the starch-resin copolymer from the compounding line was noted to be at 0.58%.

Exemplary Batch Reactor Process—2

In the following process, the starch was obtained from Tate & Lyle. MAH was obtained from Brenntag as Maleic Anhydride Brickets. Glycerol (99.9% pure) was obtained from Brenntag. The water used was standard tap water in the inventor's facility in Newmarket, Ontario, Canada. Peroxide was obtained from Akzo Nobel as Trigonox™ 101. Polyester was obtained from BASF AG as Ecoflex™ FB1200.

In a 600 litre reactor, 136 kg of Starch at 178° F. was dried down to a moisture content of 2.0% at a vacuum of 14.5″ of Hg below atmospheric. To accelerate the drying process dry nitrogen was added to the Littleford reactor. MAH brickets were ground to a fine powder and introduced into the dry starch under continuous agitation for a period of 15 minutes. During that period an 9° F. increase in temperature of the starch was observed. Following which a mixture of glycerol, water and peroxide was sprayed on to the starch. A temperature raise was noted in the reactor; the material temperature increased 19° F. to 206° F. within 17 minutes. Vacuum was reinitialized and drawn down to 2.6%. At that point the material was emptied from the Littleford reactor and weighted up for compounding with the polyester. The starch-resin copolymer starch was light in colour, dry to the touch, and easy to form a ball under slight pressure. The final moisture of the starch-resin copolymer from the compounding line was noted to be at 0.48%.

Starch-Resin Copolymer Properties from Batch Reactor Processes 1 and 2

The following tables 5a-5c outline the properties of the starch-resin copolymers produced by batch reactor processes 1 and 2 as described above.

TABLE 5a
Starch-resin copolymer Properties from
Batch Reactor Processes 1 and 2

| Polymer Property | | Process-1 | Process-2 |
|---|---|---|---|
| MFR [g/10 minutes] | 190° C./2.16 kg | 2.1 | 1.29 |
| Density [g/cc] | | 1.23 | 1.23 |
| Film Sample Thickness | | 0.0027″ | |

TABLE 5b
Tensile Properties Machine Direction
from Batch Reactor Processes 1 and 2

| Tensile Property | Process-1 | Process-2 |
|---|---|---|
| Yield Strength [psi] | 1,680 | 1,330 |
| Tensile at Break [psi] | 1,310 | 1,030 |
| Yield Elongation [%] | 233 | 220 |
| Elongation at Break [%] | 245 | 220 |
| Modulus (Tangent 3%) [psi] | 10,400 | 7,830 |
| Tensile Strength [psi] | 1,680 | 1,350 |

TABLE 5c
Tensile Properties Transverse Direction
from Batch Reactor Processes 1 and 2

| Tensile Property | Process-1 | Process-2 |
|---|---|---|
| Yield Strength [psi] | 570 | 1,960 |
| Tensile at Break [psi] | 1,750 | 1,960 |
| Yield Elongation [%] | 14 | 420 |
| Elongation at Break [%] | 590 | 420 |
| Modulus (Tangent 3%) [psi] | 10,700 | 11,000 |

Exemplary Batch Reactor Process—3

In the following process, the starch was obtained from Tate & Lyle. MAH was obtained from Brenntag as Maleic Anhydride Brickets. Glycerol (99.9% pure) was obtained from Brenntag. The water used was standard tap water in the inventor's facility in Newmarket, Ontario, Canada. Peroxide was obtained from Akzo Nobel as Trigonox™ 101. Polyester was obtained from BASF AG as Ecoflex™ FB1200.

In the 600 litre reactor, 136 kg of Starch at 178° F. was dried down to 2.4% under 12.0″ of Hg below atmopheric of vacuum. To accelerate the drying process, dry nitrogen was added to the Littleford. MAH brickets were ground to a fine powder and introduced into the dry starch under continuous agitation for a period of 15 minutes. During that period an 11° F. increase in temperature of the starch was noted. Following which a mixture of glycerol, water and peroxide was sprayed on to the starch. Once again, temperature raise was noted in the reactor. The material temperature increased 22° F. to 211° F. within 19 minutes. Vacuum was re-initialize and drawn down to 2.9%. At that point the material was emptied from the Littleford and weighted up for compounding with the polyester. The starch-resin copolymer was light in colour, dry to the touch, however easy to form a ball under slight pressure. The final moisture of the starch copolymer from this compounding line was observed to be at 0.41%.

It is observed that with a 50% thinner film, there is no loss in tensile or elongation properties relative to a conventional starch-based film.

Exemplary Batch Reactor Process—4

In the following process, the starch was obtained from Pennwalt. MAH was obtained from Brenntag as Maleic Anhydride Brickets. Glycerol (99.9% pure) was obtained from Brenntag. The water used was standard tap water in the inventor's facility in Newmarket, Ontario, Canada. Peroxide was obtained from Akzo Nobel as Trigonox™ 101. Polyester was obtained from Samsung as Enpol™ 7070.

In the 600 litre reactor, 136 kg of Starch at 178° F. was dried down to 2.3% under 13.5″ of Hg below atmospheric pressure of vacuum. To accelerate the drying process dry nitrogen was added to the Littleford reactor. MAH brickets were ground to a fine powder and introduced into the dry starch under continuous agitation for a period of 15 minutes. During that period an 11° F. increase in temperature of the starch was observed. Following which a mixture of glycerol, water and peroxide was sprayed on to the starch. Once again, temperature raise was observed in the reactor; the material temperature increased 19° F. to 208° F. within 18 minutes. Vacuum was reinitialized and drawn down to 3.6%. At that point the material was emptied from the Littleford reactor and weighted up for compounding with the polyester. The starch-resin copolymer was light in colour, dry to the touch, and easy to form a ball under slight pressure. The final moisture of the starch-resin copolymer from this compounding line was observed to be at 0.52%.

The following tables 6a-6c outline the properties of the starch-resin copolymers produced by batch reactor processes 3 and 4 as described above.

TABLE 6a
Starch-resin copolymer Properties from
Batch Reactor Processes 3 and 4

| Polymer Property | | Process-3 | Process-4 |
|---|---|---|---|
| MFR [g/10 minutes] | 190° C./2.16 kg | 1.56 | 1.29 |
| Density [g/cc] | | 1.23 | 1.23 |
| Film Sample Thickness | | 0.00045″ | 0.001″ |

TABLE 6b
Tensile Properties Machine Direction
from Batch Reactor Processes 3 and 4

| Tensile Property | Process-3 | Process-4 |
|---|---|---|
| Yield Strength [psi] | 3,470 | 1,370 |
| Tensile at Break [psi] | 92.3 | 1,280 |
| Yield Elongation [%] | 170 | 220 |
| Elongation at Break [%] | 192 | 220 |
| Modulus (Tangent 3%) [psi] | 24,300 | 7,830 |
| Tensile Strength [psi] | 3,500 | 1,360 |

TABLE 6c
Tensile Properties Transverse Direction
from Batch Reactor Processes 3 and 4

| Tensile Property | Process-3 | Process-4 |
|---|---|---|
| Yield Strength [psi] | 3,250 | 1,830 |
| Tensile at Break [psi] | 5.14 | 1,830 |
| Yield Elongation [%] | 247 | 390 |
| Elongation at Break [%] | 340 | 410 |
| Modulus (Tangent 3%) [psi] | 17,300 | 10,130 |
| Tensile Strength [psi] | 3,760 | 1,940 |

### Example 4

### Extrusion Reactor Process

The same steps for the reaction and generation of the described starch-resin copolymer can be carried out in an extrusion type reactor. The general process for producing the starch-resin copolymer in an extrusion reactor is generally similar to that carried out in a batch reactor, but can be divided up into multiple stages as follows. In the first stage, the starch is dried to the desired level. The second stage is a melt reaction with MAH. The third stage involves the formation of the thermal plastic chemically modified starch with the introduction of the glycerol, water and peroxide (CTPS). In the fourth stage, the polyester is introduced and reacted with the CTPS. In stage five, the material moves through a section under vacuum that acts like a thin film evaporator and rooms excess moisture. In stage six, the material is conveyed through a gear pump or conveyer screw to increase pressure at the die head for pelletization. The same compositional ranges used for the batch reactor shown in Table 1 can be applied to the described extrusion reactor.

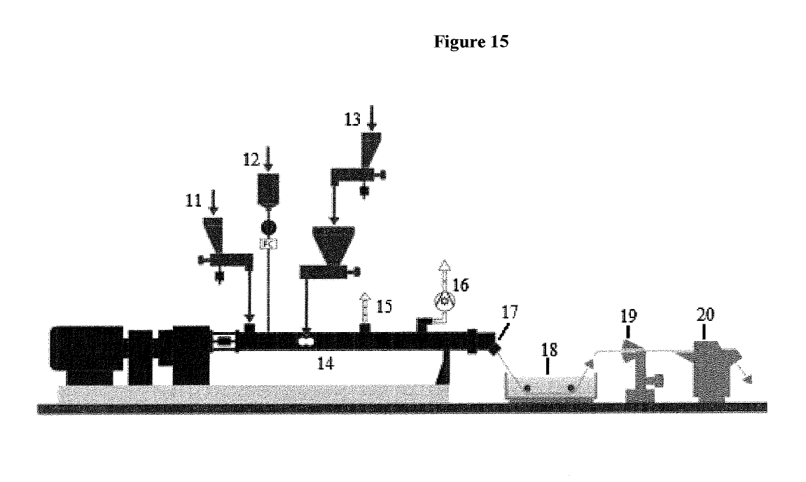

One example of a two-stage extrusion reactor, a Kombiplast™ extruder, is shown in FIG. 15. As shown in FIG. 15, (1) is a twin-screw side feeder, (2) is a twin screw compounder, (3) is a single-discharge screw mixer, (4) is an eccentric pelletizer, (5) is a vacuum degassing section, and (6) is a further vacuum degassing section between the twin screw compounder (2) and the single-discharge screw (3).

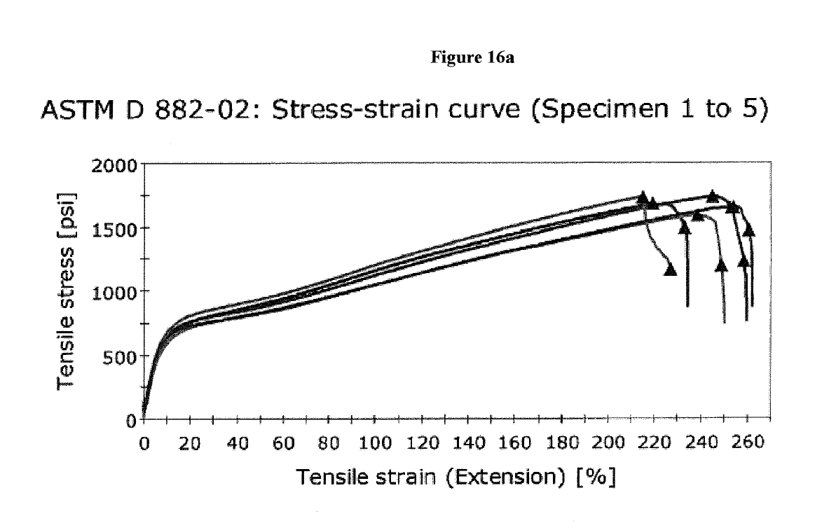

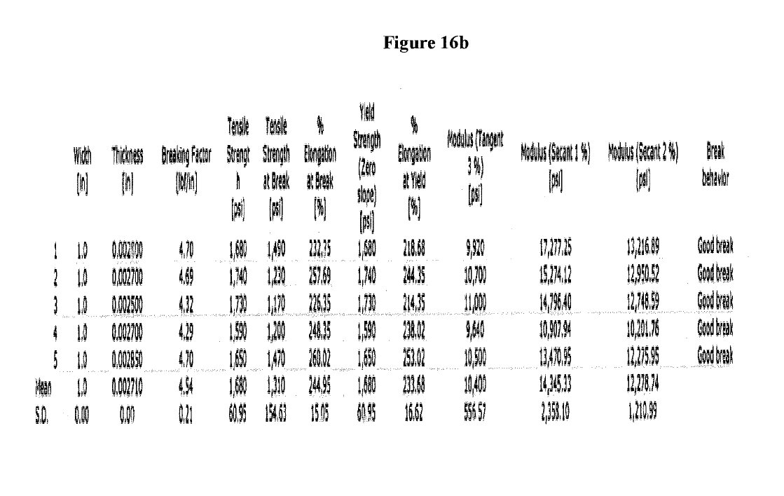

Another exemplary reactor for the present process is shown in FIG. 16. FIG. 16 depicts a schematic of a typical set up for the production of biodegradable products. The starch or powder premix is put into the reactor at powder port (11). Plasticizer and/or liquid additives are applied at liquid port (12). Polyester or resin is applied at resin port (13). Twin-screw side-feeder reactor (4) mixes the components. Atmospheric degassing is applied at Atmospheric degassing port (15) and vacuum degassing is applied at vacuum port (16). Die head (17) is the exit point of the starch-resin copolymer from the reactor into water bath (18). The starch-resin copolymer is then exposed to airknife (19) and strand pelletizer (20).

All publications, patents and patent applications mentioned in this Specification are indicative of the level of skill of those skilled in the art to which this invention pertains and are herein incorporated by reference to the same extent as if each individual publication, patent, or patent application was specifically and individually indicated to be incorporated by reference.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A process for making a starch-resin copolymer, the process comprising:
a) mixing at least one of a dicarboxylic acid and a dicarboxylic acid anhydride with a starch or modified starch to yield a starch mixture;
b) adding a liquid mixture comprising water and a polyol to the starch mixture to produce a functionalized starch; and
c) mixing the functionalized starch with a resin to produce the starch-resin copolymer.
wherein prior to mixing the one of the dicarboxylic acid and the dicarboxylic acid anhydride with the starch, the starch has a moisture content of not greater than about 8% wt.

2. (canceled)

3. (canceled)

4. The process of claim 1, wherein prior to step a), a drying step is carried out to dry the starch or modified starch, to generate the starch or modified starch having a moisture content of not greater than about 8% wt.

5. The process of claim 4, wherein the drying step is carried out at a pressure of between about 5 to 20 inches of Hg below atmospheric and at a temperature between about 140 to 280° F.

6. (canceled)

7. (canceled)

8. The process of claim 1, wherein the drying step is performed under a pressure of substantially dry gas, such as substantially dry air, nitrogen, or a combination thereof.

9. The process of claim 1, further comprising d) drying the starch-resin copolymer to a moisture content of not greater than 3%.

10. (canceled)

11. (canceled)

12. The process of claim 1, wherein the liquid mixture further comprises an initiator.

13. The process of claim 12, wherein the initiator is an organic peroxide.

14. The process of claim 1, wherein the resin is at least one of a polyester selected from the group consisting of Poly(lactic acid) or polylactide (PLA); poly(glycolic acid) or polyglycolide (PGA); Poly(hydroxyester ether) (PHEE); Adipic acid-diglycidyl ether of Bisphenol A; Poly(hydroxybutyrate-co-valerate); Poly(butylene-succinate) (PBSA); Poly(caprolactone) (PCL); Butanediol-terephthalate-adipate terpolymers (PBAT); Cellulose acetate; Poly(vinyl alcohol) (PVOH); poly(vinylacetate-co-vinylalcohol) (PVAc/VA); poly(β-hydroxybutyrate) (PHB); Poly(β-hydroxybutyrate-co.beta.-hydroxyvalerate) (PHBN); poly(β-hydroxyalkanoates) (PHA); Poly(ester amide) (PEA) and other, biodegradable aliphatic polyesters, and aliphatic-aromatic copolyesters.

15. The process of claim 1, wherein the resin is biodegradable, compostable, or both.

16. The process of claim 1, wherein the at least one of the dicarboxylic acid and dicarboxylic acid anhydride is succinic acid, maleic acid, phthalic acid, citric acid and fumaric acid, succinic anhydride, maleic anhydride, phthalic anhydride, citric anhydride or fumaric anhydride.

17. The process of claim 1, wherein the polyol is glycerol, ethylene glycol, polyethylene glycol, propylene glycol, polypropylene glycol, sorbitol, or a combination thereof.

18. The process of claim 1, wherein the mixing the functionalized starch with a resin to produce the starch-resin copolymer is carried out at a temperature of between about 120 to 350° F.

19. (canceled)

20. (canceled)

21. The process of claim 1, carried out in a batch reactor or a continuous reactor.

22. (canceled)

23. The process of claim 1, wherein the amount of functionalized starch is 40-60% by weight of the starch-resin copolymer.

24. A starch-resin copolymer produced by the process of claim 1.

25. A starch-resin copolymer comprising:
a) a functionalized starch comprising a reaction product of a starch or modified starch, and one of a dicarboxylic acid or a dicarboxylic acid anhydride, a polyol, water, and optionally an initiator; and
b) a resin,
wherein the starch or modified starch used to manufacture the functionalized starch has a moisture content of less than 8%.

26. (canceled)

27. (canceled)

28. (canceled)

29. (canceled)

30. (canceled)

31. The starch-resin copolymer of claim 25, wherein the resin is at least one of a polyester selected from the group consisting of Poly(lactic acid) or polylactide (PLA); poly(glycolic acid) or polyglycolide (PGA); Poly(hydroxyester ether) (PHEE); Adipic acid-diglycidyl ether of Bisphenol A; Poly(hydroxybutyrate-co-valerate); Poly(butylene-succinate) (PBSA); Poly(caprolactone) (PCL); Butanediol-terephthalate-adipate terpolymers (PBAT); Cellulose acetate; Poly(vinyl alcohol) (PVOH); poly(vinylacetate-co-vinylalcohol) (PVAc/VA); poly(β-hydroxybutyrate) (PHB); Poly(β-hydroxybutyrate-co.beta.-hydroxyvalerate) (PHBN); poly(β-hydroxyalkanoates) (PHA); Poly(ester amide) (PEA) and other, biodegradable aliphatic polyesters, and aliphatic-aromatic copolyesters.

32. The starch-resin copolymer of claim 25, wherein the one of the dicarboxylic acid and dicarboxylic acid anhydride is succinic acid, maleic acid, phthalic acid, citric acid and fumaric acid, succinic anhydride, maleic anhydride, phthalic anhydride, citric anhydride or fumaric anhydride.

33. The starch-resin copolymer of claim 25, wherein the polyol is glycerol, ethylene glycol, polyethylene glycol, propylene glycol, polypropylene glycol, sorbitol, or a combination thereof.

34. The starch-resin copolymer of claim 25, wherein the starch-resin copolymer is suitable for use in a downstream process in which the copolymer is extruded, moulded, blow-moulded, blown into a film, cast into a film, compression moulded, injection moulded, or vacuum formed, or can be used as a hot melt adhesive, coating, or bonding agent or to make fabrics, non woven fabrics or extruded filaments.

35. (canceled)

36. (canceled)

37. (canceled)
